(19) United States
(12) Patent Application Publication
(10) Pub. No.: US 2026/0299188 A1
(43) Pub. Date: Oct. 1, 2026

(54) MULTICORE FIBER CONNECTION COMPONENT

(71) Applicant: PHOTONIC SCIENCE TECHNOLOGY INC., Chitose City (JP)

(72) Inventors: Toshihiro SUDA, Chitose City (JP); Yusuke FUJII, Chitose City, Hokkaido (JP); Soichi KOBAYASHI, Chitose City (JP)

(73) Assignee: PHOTONIC SCIENCE TECHNOLOGY INC., Chitose City (JP)

(21) Appl. No.: 19/307,514

(22) Filed: Aug. 22, 2025

(30) Foreign Application Priority Data
Mar. 27, 2025 (JP) 2025-053566

(51) Int. Cl. G02B 6/02

(52) U.S. Cl. CPC G02B 6/02042

(57) ABSTRACT

A multicore fiber connection component includes a plurality of double-core optical fibers, each double-core optical fiber having a first core disposed at a center, a second core disposed around the first core, and a cladding disposed around the second core. A capillary holds the plurality of double-core optical fibers in an arrangement corresponding to cores of a multicore fiber. The cladding of each double-core optical fiber is welded to the capillary. The capillary includes a tapered section having an outer diameter that decreases from a tip end section toward a rear end section. The second core and the cladding have a relative refractive index difference in a range of 0.3% to 1.0%. This allows fan-in/fan-out of a multicore fiber with low loss and to set a thickness of MCF-FIFO within 1 mm.

### CROSS-REFERENCE TO RELATED APPLICATIONS

This application claims priority under 35 U.S.C. § 119(a) to Japanese Patent Application No. JP2025-053566, filed on Mar. 27, 2025, the entire disclosure of which is incorporated herein by reference.

### BACKGROUND OF THE DISCLOSURE

### 1. Field of the Disclosure

The present disclosure relates to a multicore fiber connection component capable of fan-in/fan-out of a multicore fiber.

### 2. Description of Related Art

Multicore fibers (may be abbreviated as an “MCF” below) are expected because of higher capacity for dealing with congested optical fiber wirings in a data center. Therefore, downsizing of MCF-FIFO that performs fan-in/fan-out of a multicore fiber is expected.

Multicore fiber connection components, which meet such requirements, have been proposed. See, for example, Japanese Patent No. 7483281 (hereinafter: Patent Literature 1). In Patent Literature 1, a plurality of double-core fibers, arranged in accordance with the core arrangement of the MCF, are fixed with a capillary, and one end section of the capillary is reduced in diameter together with the capillary. As a result, an inner first core positioned at one end of the capillary can be connected to a core of a single core fiber, and an outer second core positioned at the other end of the capillary can be connected to the core of the MCF.

In Patent Literature 1, in order to shorten the length of MCF-FIFO, the taper length at the time of diameter reduction is shortened. Therefore, a relative refractive index difference Δ₁ between the first core and the second core is set to 0.32 or more and 0.36 or less, and a relative refractive index difference Δ₂ between the second core and a cladding is set to 0.4 or more and 0.6 or less.

### SUMMARY OF THE DISCLOSURE

Although reducing the thickness of a mechanically transferable (MT) bundling single core fibers is desired, the thickness of the MCF-FIFO in Patent Literature 1 is more than 1 mm depending on a reduction ratio. Therefore, an object of the present disclosure is to enable fan-in/fan-out of a multicore fiber with low loss and to set a thickness of MCF-FIFO within 1 mm.

A multicore fiber connection component of the present disclosure includes a plurality of double-core fibers each including a first core positioned at a center, a second core put around the first core, and a cladding put around the second core, and a capillary that holds the plurality of double-core fibers in an arrangement corresponding to cores of a multicore fiber, in which the cladding, positioned in the plurality of double-core fibers, is welded to the capillary, the capillary includes a tapered section whose outer diameter narrows from a tip end section toward a rear end section, and a relative refractive index difference between the second core and the cladding is 0.3% or more and 1.0% or less.

A mode field diameter (MFD) of the first core at the tip end section and an MFD of the second core at the rear end section are approximately 9 μm. This value corresponds to the MFD of the core of the single mode fiber, and may be any value that is 8.6 μm or more and 9.2 μm or less. Examination of a connection loss with the MFD, which is approximately 9 μm, has shown that the connection loss is 0.3 dB or less under a condition where the opposing MFD is 7.5 μm or more and 11.5 μm or less. Therefore, the present disclosure has a value being 0.3% or more and 1.0% or less, which is a relative refractive index difference, between the second core and the cladding, bringing about a connection loss, with the MCF, kept 0.3 dB or less.

When the wavelength is 1.55 μm, any value that is 0.4% or more and 1.0% or less can be adopted as the relative refractive index difference between the second core and the cladding. As a result, the connection loss with the MCF can be reduced to 0.3 dB or less. In addition, any value that is 5.5 or more and 8.0 or less can be adopted as a reduction ratio of the tapered section.

When the wavelength is 1.31 μm, any value that is 0.3% or more and 0.75% or less can be adopted as the relative refractive index difference between the second core and the cladding. As a result, the connection loss with the MCF can be reduced to 0.3 dB or less. In addition, any value that is 6.5 or more and 8.0 or less can be adopted as the reduction ratio of the tapered section.

Note that the above disclosures can be combined as much as possible.

An advantageous effect is that the multicore fiber connection component of the present disclosure can perform fan-in/fan-out of the multicore fiber with low loss, and can bring about the thickness of the MCF-FIFO that is set within 1 mm.

### BRIEF DESCRIPTION OF DRAWINGS

FIG. 1 is a configuration example of a multicore fiber connection component according to an embodiment of the present disclosure.

FIG. 2 is a configuration example of the multicore fiber connection component according to the embodiment of the present disclosure.

FIG. 3 is a view for describing a refractive index of a double-core fiber.

FIG. 4 is an explanatory view of a capillary according to an embodiment of the present disclosure.

FIG. 5 illustrates an example of a connection loss with an MCF.

FIG. 6 illustrates an example of an MFD versus a value of a relative refractive index difference Δ₂ satisfying a single mode condition where a wavelength is 1.55 μm.

FIG. 7 illustrates an example of the MFD versus the value of the relative refractive index difference Δ₂ satisfying a single mode condition where the wavelength is 1.31 μm.

FIGS. 8A-D show an explanatory view of a producing step according to an embodiment of the present disclosure.

### DETAILED DESCRIPTION OF THE DISCLOSURE

Hereinafter, embodiments of the present disclosure will be described in detail with reference to the drawings. Note that the present disclosure is not limited to the following embodiments. These embodiments are merely examples, and the present disclosure can be implemented in a form with various modifications and improvements based on the knowledge of those skilled in the art. Note that constituent elements indicated by the same reference signs in the present specification and the drawings are the same elements.

### First Embodiment

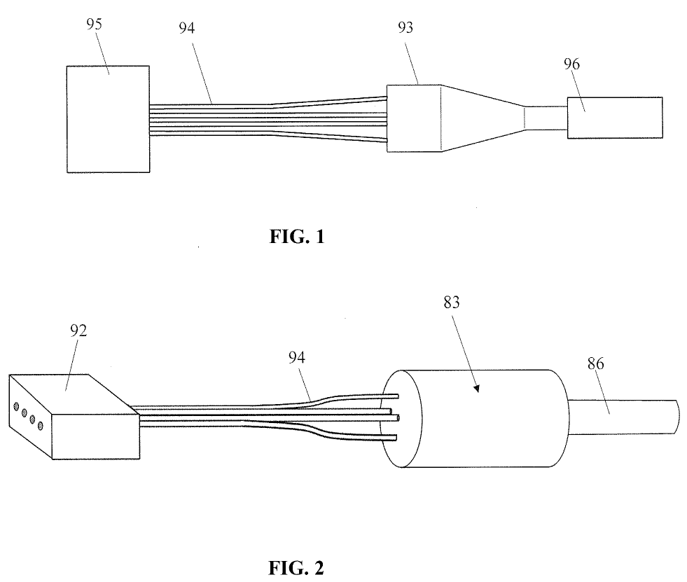

FIG. 1 is a view illustrating an embodiment of a multicore fiber connection component according to the present disclosure. The multicore fiber connection component of the present embodiment is a fan-in/fan-out component for an MCF that couples light, from each core positioned in the MCF, to a single core single-mode fiber. The multicore fiber connection component of the present disclosure includes an MPO connector 95, a double-core fiber 94, a capillary 93, and a multicore fiber connector 96.

FIG. 2 is a view illustrating an embodiment of the multicore fiber connection component according to the present disclosure. This drawing illustrates a state in which the capillary 93 is contained in a housing 83. A mechanically transferable (MT) ferrule 92 contained in a housing of the MPO connector 95 and the capillary 93 in the housing 83 are connected by a double-core fiber 94.

In the present embodiment, an example in which an MCF 86 in the multicore fiber connector 96 has four cores and is equipped with four double-core fibers 94 will be described. The tip ends of each double-core fibers 94 are separately positioned at a connection ends of the MT ferrule 92. As a result, in the multicore fiber connection component of the present disclosure, four single-mode fibers are connected to the MT ferrule 92, so that light, from the cores positioned in the MCF 86, can be coupled to the single-mode fibers individually.

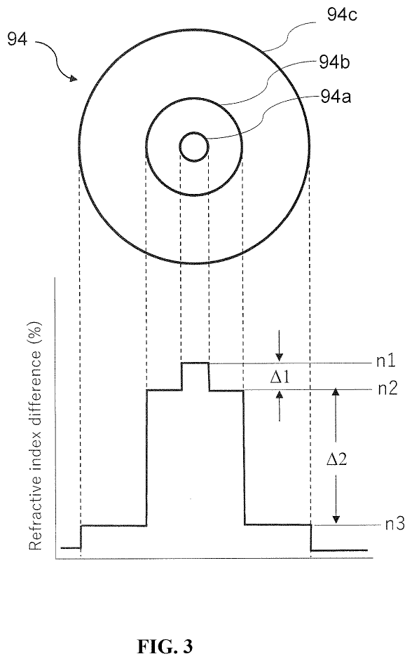

FIG. 3 illustrates an example of the refractive index distribution of the double-core fiber 94. The double-core fiber 94 is a double-core fiber in which a second core 94b having a refractive index n₂ is put around a first core 94a having a refractive index n₁, and a cladding 94c having a refractive index ns is put around the second core 94b.

As a relative refractive index difference Δ₁ between the refractive index n₁ and the refractive index n₂, a value similar to a relative refractive index difference between the core and the cladding of the single-mode fiber used in wavelength bands of 1.55 μm and 1.31 μm can be adopted, and can be exemplified by, for example, a value that is 0.3% or more and 0.36% or less. By virtue of this, the first core 94a can be connected to the single-mode fiber with a connection loss kept 0.5 dB or less. As a relative refractive index difference Δ₂, a value larger than Δ₁ can be adopted, and as described later, a value that is 0.3% or more and 1.0% or less can be adopted.

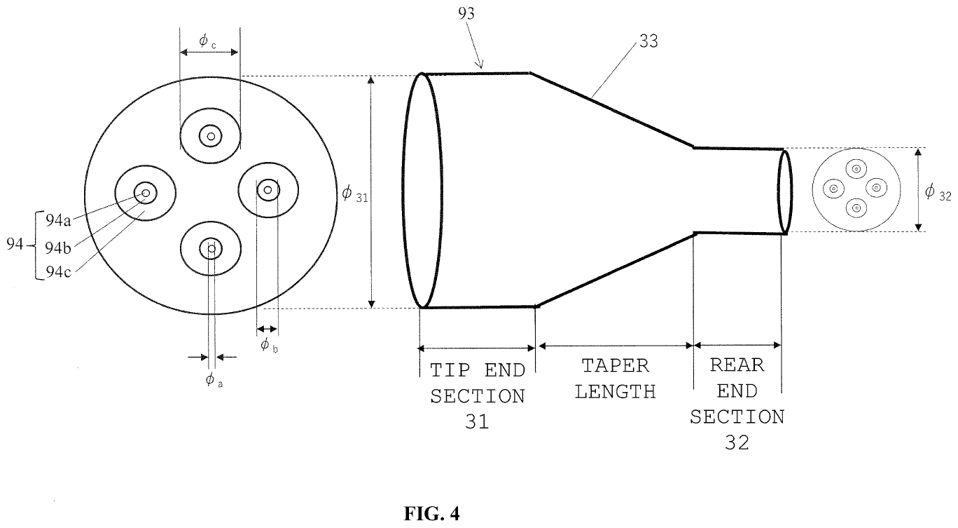

FIG. 4 illustrates a configuration example of the capillary 93 and the double-core fibers 94. Each of the double-core fibers 94 extending from the MT ferrule 92 is received by the capillary 93. The capillary 93 and the double-core fiber 94 are integrally formed by welding, and have a tapered section 33 whose outer diameter tapers off from φ₃₁ to φ₃₂, and narrows from a tip end section 31 toward a rear end section 32.

Here, the capillary 93 holds a plurality of double-core fibers 94 in an arrangement corresponding to the cores of the MCF 86. The four double-core fibers 94 are tapered off to four cores by way of the tapered section 33, and compose an MCF structure the outer diameter of which is uniform at the rear end section 32. As a result, each second core 94b of the rear end section 32 can be connected to each core of the MCF 86. The rear end section 32 may be attached to a multicore fiber connector 96 for connection with the MCF 86, or may be fusion-spliced to the MCF 86.

In the present disclosure, the first core 94a at the tip end section 31 and the second core 94b at the rear end section 32 have a mode field diameter (MFD) that is about 9 μm similar to that of a core of a single-mode fiber. A value that is about 9 μm may be any value that is 8.6 μm or more and 9.2 μm or less. When the MFD of the core positioned in the MCF 86 is about 9 μm, any value that is 5.5 or more and 8.0 or less can be adopted as the reduction ratio after stretching.

When the reduction ratio from the tip end section 31 to the rear end section 32 is set to 5.5, the MFD of the first core 94a that is set to 8.6 μm at the tip end section 31 is 1.56 μm at the rear end section 32. Therefore, when the wavelength is 1.55 μm, the connection loss with the MCF 86 can be reduced by setting the reduction ratio from the tip end section 31 to the rear end section 32 to 5.5 or more.

In addition, when the reduction ratio from the tip end section 31 to the rear end section 32 is set to 6.5, the MFD of the first core 94a that is set to 8.6 μm at the tip end section 31 is 1.32 μm at the rear end section 32. Therefore, when the wavelength is 1.31 μm, the connection loss with the MCF 86 can be reduced by setting the reduction ratio from the tip end section 31 to the rear end section 32 to 6.5 or more.

On the other hand, when the reduction ratio after stretching is 8.0, the MFD of the second core 94b that is set to 9.2 μm at the rear end section 32 is 73.6 μm at the tip end section 31. The MFD of the second core 94b that is 73.6 μm requires the outer diameter Qc that is chosen to be close to 1000 μm. Therefore, for the sake of the thickness of the MCF-FIFO that is set to 1 mm or less, the reduction ratio from the tip end section 31 to the rear end section 32 is preferably 8.0 or less.

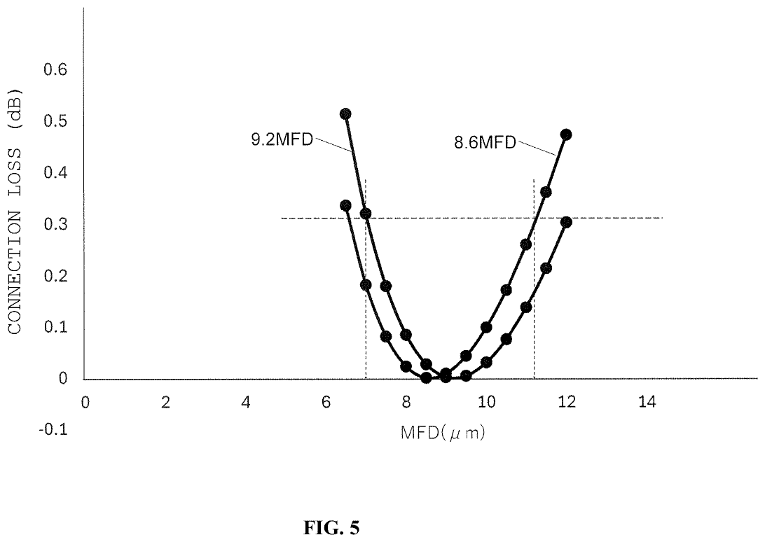

FIG. 5 illustrates an example of the connection loss versus the MFD that is about 9 μm. The horizontal axis indicates the MFDs disposed opposite to each other. This example shows the followings: when the MFDs disposed opposite to each other are 7.5 μm or more and 11.5 μm or less, the connection loss with the MFDs that is 8.6 μm or more and 9.2 μm or less is 0.3 dB or less. Therefore, by setting the MFD of the second core 94b at the rear end section 32 to 7.5 μm or more and 11.5 μm or less, the connection loss with the MCF 86 can be kept 0.3 dB or less.

The relative refractive index difference Δ₂ is determined such that the second core 94b at the rear end section 32 and the core of the MCF 86 satisfy the single-mode condition therebetween. Specifically, it is defined that the V number V expressed by the following formula is 2.405 or less.

$$V = 2 Π / λ \cdot a \cdot n √ 2 Δ \qquad Formula ( 1 )$$

λ is a wavelength, a is a core radius, n is a refractive index of the core, and Δ is a relative refractive index difference.

Δ is expressed by the following formula using n.

$$Δ = ( n - {n}_{0} ) / n \qquad Formula ( 2 )$$

In the present embodiment, the refractive index of quartz glass is used as no.

In the present embodiment, the condition for connection of the second core 94b to the core of the MCF 86 is obtained by setting A in Formula (1) to Δ₂ and comparing the MFD of the second core 94b obtained from “a” with the MFD of the core positioned in the MCF 86.

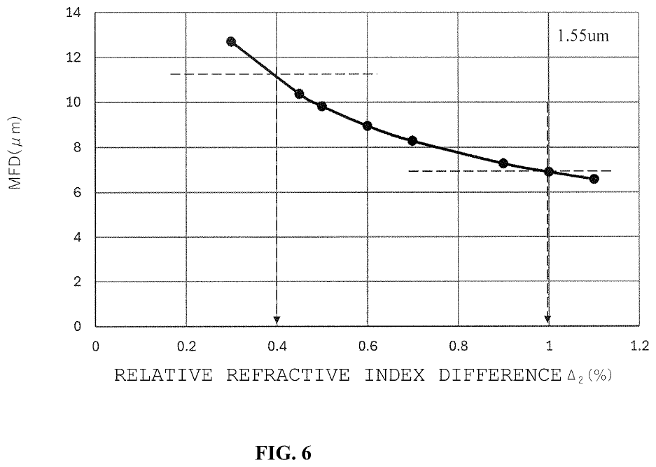

FIG. 6 illustrates an example of the value of the relative refractive index difference Δ₂ satisfying the single mode condition where the wavelength is 1.55 μm. For calculation of Δ₂, n₀=1.444 at a wavelength that was 1.55 μm was used. When the relative refractive index difference Δ₂ was 0.4% or more and 1.0% or less, the MFD of the second core 94b at the rear end section 32 was 7.5 μm or more and 11.5 μm or less.

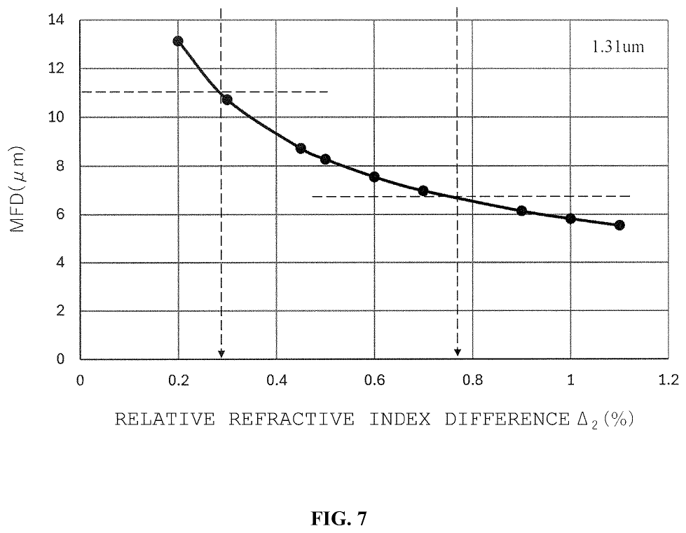

FIG. 7 illustrates an example of the value of the relative refractive index difference Δ₂ satisfying the single mode condition where the wavelength is 1.31 μm. For calculation of Δ₂, n₀=1.447 at a wavelength that was 1.31 μm was used. When the relative refractive index difference Δ₂ was 0.3% or more and 0.75% or less, the MFD of the second core 94b at the rear end section 32 was 7.5 μm or more and 11.5 μm or less.

In the present embodiment, both the connection of the first core 94a to the core of the single-mode fiber and the connection of the second core 94b to the core of the multicore fiber are designed to satisfy the single-mode condition. Therefore, the multicore fiber connection component of the present embodiment can lessen the connection loss of the MCF-FIFO.

Further, the multicore fiber connection component of the present embodiment is designed so that the thickness of the MCF-FIFO can be kept 1 mm or less. Therefore, in the multicore fiber connection component of the present embodiment, the thickness of the MCF-FIFO, capable of performing fan-in/fan-out of the multicore fiber with low loss, can be set within 1 mm.

### Second Embodiment

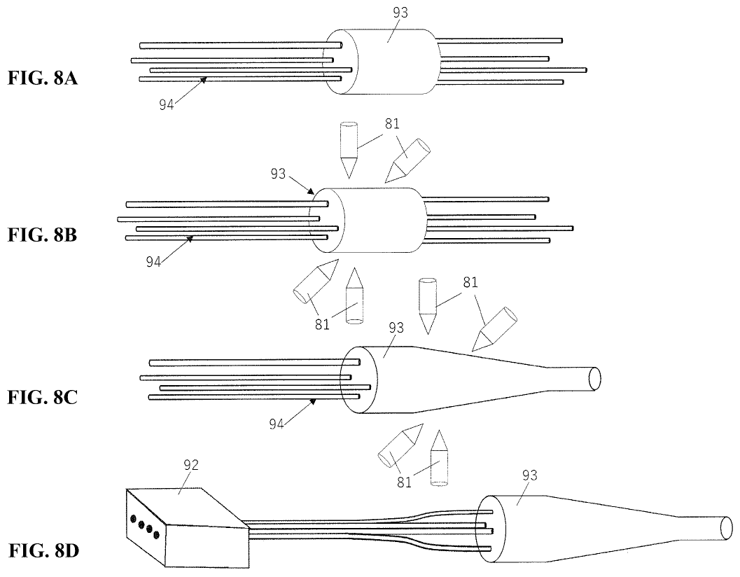

A method for manufacturing a multicore fiber connection component of the present disclosure will be described with reference to FIGS. 8A-D

### Welding Step

The double-core fiber 94 is inserted into the hole of the capillary 93 (FIG. 8A), and the double-core fiber 94 and the capillary 93 are welded (FIG. 8B). The welding can be performed, for example, by decompressing the entire system or the hole of the capillary 93 and performing arc discharge using a plurality of electrodes 81. The cross-sectional view of the capillary 93 after welding corresponds to the left view of FIG. 4.

Here, the outer diameter φ_{c} of the double-core fiber 94 is set to 125 μm, and the MFD of the first core 94a is set to 8.6 μm or more and 9.2 μm or less so that the double-core fiber can be connected to the single-mode fiber to which the MT ferrule 92 is connected. The MFD of the second core 94b is determined by the reduction ratio thereof to the MFD of the first core 94a. As the reduction ratio, any value that is 5.5 or more and 8.0 or less can be adopted. For example, when the reduction ratio is 7 times, the MFD of the second core 94b is 60.2 μm.

### Stretching Step

The tip end section 31 of the capillary 93 is left and stretched from the middle of the capillary 93 (FIG. 8C). For example, the tapered section 33 is formed by leaving 10 mm from the tip end section 31 and stretching (FIG. 8C). The stretching can be performed by, for example, arc discharge using a plurality of electrodes 81, and a stretching section is 5 mm or more and 20 mm or less long. As the length of the rear end section 32, any length capable of connection of the multicore fiber connector 96 can be adopted, and for example, in preparation for fusion splicing, the length is set to 10 mm or more and 20 mm or less.

The cross-sectional view of the rear end section 32 after the stretching is equivalent to the right view of FIG. 4. The tip end section 31 is in a state where the double-core fiber 94 is inserted into the hole in the capillary 93 and welded under decompression by arc discharge heating, the tapered section 33 is in a state where the further welded capillary 93 is stretched by arc discharge heating and processed like the MCF, and the rear end section 32 has an MCF structure.

Here, although the arc discharge is used as a heat source in the present embodiment, another heat source may be used, instead of the arc discharge, as the heat source. For example, a carbon heater, a ceramic heater, or an oxyhydrogen burner may be used. However, when downsizing is considered, a heat source having a short heating distance and a desired melting point is desirable.

In addition, in order to obtain the values of the relative refractive index differences Δ₁ and Δ₂, it is desirable to perform production by using germanium oxide as an additive for quartz glass and adding the germanium oxide to the first core 94a and the second core 94b.

### MT Ferrule Connection Step

Each double-core fiber 94 is connected to the MT ferrule 92 (FIG. 8D). As a result, the multicore fiber connection component according to the present disclosure as illustrated in FIG. 2 can be manufactured.

Note that, after the welding step, a coating material may be applied to each of the double-core fibers 94. This can preserve the optical fiber strength before removing the coating of the double-core fiber 94. Here, a plurality of double-core fibers 94 may be positioned in the coating. For example, all the double-core fibers 94 may be protected with a common coating so that a bending radius equal to or larger than the allowable curvature radius R is retained.

In addition, in the above-described embodiments, an example of a multicore fiber in which the number of cores is four and the cores are arranged at equal distances from the central axis of the multicore fiber has been described, but the present disclosure is not limited thereto. The number of cores may be five or more, and the arrangement of the cores may not be arranged at the equal distance from the central axis of the multicore fiber.

### Experimental Examples

The multicore fiber connection component of the present disclosure was produced based on the following design, the rear end section 32 and the MCF 86 were fusion-spliced, an insertion loss of the MCF-FIFO was measured, and the result shows that the insertion loss was 0.5 dB or less. The crosstalk was measured, and the result shows that the crosstalk was-45 dB or less.
Relative refractive index difference Δ₁: 0.3%
Relative refractive index difference Δ₂: 1.0%
MFD of first core 94a at tip end section 31: 8.6 μm
MFD of first core 94a at rear end section 32: 1.2 μm
MFD of second core 94b at tip end section 31: 60.2 μm
MFD of second core 94b at rear end section 32: 8.6 μm
Reduction ratio from tip end section 31 to rear end section 32: 7

Reference Signs List

| | |
|---|---|
| 31 | tip end section |
| 32 | rear end section |
| 33 | tapered section |
| 81 | electrode |
| 83 | housing |
| 86 | multicore fiber |
| 92 | MT ferrule |
| 93 | capillary |
| 94 | double-core fiber |
| 94a | first core |
| 94b | second core |
| 94c | cladding |
| 95 | MPO connector |
| 96 | multicore fiber connector |

What is claimed is:

1. A multicore fiber connection component comprising:
a plurality of double-core fibers, each double-core optical fiber comprising a first core positioned at a center of the double-core optical fiber, a second core disposed around the first core, and a cladding disposed around the second core; and
a capillary that holds the plurality of double-core fibers in an arrangement corresponding to cores of a multicore fiber,
wherein the cladding of each of the plurality of double-core optical fibers is welded to the capillary,
wherein the capillary comprises a tapered section having an outer diameter that narrows from a tip end section toward a rear end section, and
wherein the second core and the cladding have a relative refractive index difference that is in a range of 0.3% to 1.0%.

2. The multicore fiber connection component according to claim 1,
wherein, when a wavelength is 1.55 μm, the relative refractive index difference between the second core and the cladding is in a range of 0.4% to 1.0%, and
wherein the tapered section has a reduction ratio that is in a range of 5.5 to 8.0.

3. The multicore fiber connection component according to claim 1,
wherein, when a wavelength is 1.31 μm, the relative refractive index difference between the second core and the cladding is in a range of 0.3% to 0.75%, and
wherein the tapered section has a reduction ratio that is in a range of 6.5 to 8.0.

4. The multicore fiber connection component according to claim 1,
wherein the first core at the tip end section has a mode field diameter (MFD) in a range of 8.6 μm to 9.2 μm, and
wherein the second core at the rear end section has an MFD in a range of 8.6 μm to 9.2 μm.
